(19) United States
(12) Patent Application Publication
(10) Pub. No.: US 2013/0203494 A1
(43) Pub. Date: Aug. 8, 2013

(54) ELECTRONIC FOOTBALL PLAYBOOK

(71) Applicant: Charles Edward Coiner, JR., Knoxville, TN (US)

(72) Inventor: Charles Edward Coiner, JR., Knoxville, TN (US)

(21) Appl. No.: 13/758,862

(22) Filed: Feb. 4, 2013

Related U.S. Application Data
(60) Provisional application No. 61/594,738, filed on Feb. 3, 2012.

(51) Int. Cl. G06F 17/30

(52) U.S. Cl. CPC G06F 17/30002
USPC 463/37; 463/43

(57) ABSTRACT

An electronic playbook may implement a play database and a playbook application to enable electronic searching and retrieval of plays. The plays may be searchable according to a formation and at least one position route. The plays may be searched using higher-level queries. Selected plays may be added to a playbook by the user, which can be distributed to other users. Video content may be linked to an individual play and played back to the user.

### CROSS REFERENCE TO RELATED APPLICATIONS

This application claims priority from U.S. Provisional Patent Application No. 61/594,738, filed on Feb. 3, 2012, entitled “PLAYBOOK MOBILE APPLICATION”, which is incorporated by reference herein in its entirety.

### BACKGROUND

1. Field of the Disclosure

The present disclosure relates to playbooks and, specifically, to an electronic playbook.

2. Description of the Related Art

American football is a game of many different philosophies and styles. Those who are involved with the game (e.g., coaches, players, personnel departments) strive to adopt a playing style that is best suited for their team. Historically, this has been accomplished by studying playbooks, video, attending clinics, and reading books authored by coaches who have had previous success in a particular system of plays. The plays may then be organized in a playbook, from which the coaches choose plays that fit the personnel and philosophy of their football team.

In practice, the plays are chosen from different systems using different vocabularies. Once the plays are chosen, the coaches adopt or create a vocabulary to identify the plays that may be unique to their football team. Using this vocabulary, the coaches may organize a group of plays into a playbook, a hardcopy or electronic collection of static images of plays. However, coaches using a simple playbook often find it difficult to locate plays they have used previously. The playbook may also provide limited support of searching for plays using relevant criteria, which can be a significant challenge when a large number of plays are being managed. There remains a need in the art for a system that permits comprehensive searching and quick accessibility of plays. Moreover, football is a game that requires multiple assistant coaches communicating with a head coach and there remains a need for the head coach to make the most playbook for any given game available to assistant coaches.

### BRIEF DESCRIPTION OF THE DRAWINGS

FIG. 1 is a block diagram of selected elements of an embodiment of a play database system;

FIG. 2 is a block diagram of selected elements of an embodiment of an electronic playbook;

FIG. 3 is a flowchart depicting selected elements of a method for using an electronic playbook;

FIGS. 4A-C illustrate application screens emphasizing a first path for identifying plays from at least one embodiment;

FIGS. 5A-C illustrate application screens emphasizing a second path for identifying plays from at least one embodiment; and

FIGS. 6A-C illustrate application screens emphasizing a third path for identifying plays from at least one embodiment.

### DESCRIPTION OF THE EMBODIMENT(S)

The game of football played in the United States involves two teams playing against each other in an offensive and defensive formation. The game involves individual plays from a line of scrimmage where the football is placed based on results of a previous play. For each game, coaches and players may come up with a plan to achieve their objectives, including developing a playbook for planning specific actions and strategies during the game. In Table 1 below, terminology that shall be used herein regarding plays is defined.

TABLE 1
Terminology for Plays

| TERM | DEFINITION |
|---|---|
| formation | an initial location of players at the beginning of |
| | a play |
| play | depending on the context, a play shall refer to: |
| | 1) an actual unit of a football game performed |
| | by the players; or |
| | 2) information or data indicating the |
| | combination of a formation and one or more |
| | routes assigned to one or more positions, and |
| | may be electronic or tangible |
| play image | a graphical representation of a play, illustrating |
| | a formation and one or more routes for one or |
| | more positions |
| playbook | a collection of plays, whether electronic or |
| | tangible |
| player | an individual assigned to any of the positions |
| position | a position indicates an initial location for one |
| | of the players and suggests a set of routes that |
| | the indicated player may have to perform |
| route, position | a path of travel, assigned to a position for a |
| route | specified play, that the player assigned to the |
| | position is expected to execute during the play |
| point of scrimmage | location of the ball at the beginning of a play, |
| | also defines a line of scrimmage |

An electronic playbook may be in the form of an application for managing plays and may include features for creating and filtering plays based on factors such as the formation used and the routes assigned to one or more positions. In certain embodiments, the application may be used on a tablet, a smart phone, or another suitable mobile device and may communicate with a database of plays referred to herein as a play database. The application may also be used on a laptop, notebook, desktop, server, or other computer system that is either mobile or stationary. The play database may be located on a remote server or locally and may include various types of data related to plays, as will be described in further detail herein. The plays in the database may include a standard set of “stock” plays and may be customized to include plays specific to coach or team. Ownership of the play database is an implementation detail and the playbook application can interact with any play database that has a compliant informational structure.

In some implementations, the application enables a user to identify, select, or otherwise access plays in the play database via a query including, as examples, a concept query, a combination query, or a route query. The query may be executed by the application in response to user input at the application interface. Based on the database query, the application interface may enable the user to identify and view one or more plays according to various criteria. For example, the concept query and the combination query may represent predefined search criteria for implementing higher level access to the play database that allows the user to focus on a given position route, a tactical responsibility for one or more position(s), or a strategic objective of position routes for a given play.

In addition to the ability to identify existing plays in the play database, at least one embodiment of the playbook application enables the user to design a new play and add it to the database. For example, a user may selection a formation and associate the formation with a new combination of one or more routes to be executed by one or more receivers to create a new play, which may then be added to the play database.

In some embodiments, the application may enable selection of the concept query using a touch interface and a displayed concept button and may allow the user to intuitively choose and view plays conceptually organized by strategies commonly applied to the game of football. In some embodiments, the application may enable selection of the combination query using a touch interface and a displayed half-field combo button and may allow the user to intuitively choose and view plays organized by route combinations for two or more players on one side of the formation. In some embodiments, the application may enable selection of the route query using a touch interface and a displayed any-route button and may enable selection of plays based on formation and the individual routes of one or more positions (i.e., receivers) by presenting the user with touch-selectable display screens for selecting a formation, a designated receiver or other position in the formation, and a particular route or responsibility that the designated position may have in the selected formation.

The application may further enable the user to identify, name, rename, group, edit, and/or save plays to a playbook that may be created, maintained, and/or distributed by the user, for example, to a team of additional users. In this manner, the application may allow a user to create playbooks for specific game circumstances. The application may support the distribution, by email or otherwise, of plays and playbooks to other users. Playbooks may include attributes for defining specific categories of players based on age, ability, or other factors, specific down and distance situations, specific opponents, specific weather conditions, and so forth. The application may also provide access to video associated with specific plays, which may be a desired convenience for coaches and players. In one embodiment, the route query may be used to integrate with video to enable the user to find plays intuitively. In some embodiments, the user may choose a route using the any-route button and watch video clips of some or all plays that include a specific route for a specific position.

Although the specific examples presented herein for descriptive clarity depict pass game plays in offensive football, the application may be used to specify formations and position routes for various game plays. The application may be used for various aspects of offensive football including the run game, play action pass game, as well as situational football including red zone plays, third down plays, short yardage plays and goal line plays. The application may be used for defensive football including finding defenses by fronts, front adjustments, stunts, dogs, blitzes, and secondary coverages. The application may be used for special teams including punt, punt return, kickoff, kickoff return, point after attempts and field goals, point after attempt blocks and field goal blocks.

In one aspect, a disclosed method for accessing plays may include receiving user input indicating a search criteria, identifying, from a database, plays matching the search criteria, and enabling a user to select the plays matching the search criteria. The search criteria may specify at least one of: a formation and a position route.

In certain embodiments, the database may store formation data for the formation, while the formation includes location data for each of a plurality of positions in the formation, and position data for each of the plurality of positions. The location data may specify a start location, relative to a point of scrimmage, in the formation, while the position data may specify a position identifier for a position in the formation. The database may store position route data for the position route. The position route data may specify a designated route for a designated position in the formation, the designated route originating from the start location for the designated position. The method operation of enabling the user to select the plays may include generating a play image for a first play matching the search criteria. The play image may represent formation data and position route data associated with the first play. The method operation of generating the play image for the first play may include at least one of retrieving at least a portion of the play image from the database, and rendering the play image using the formation data and the position route data. The search criteria may specify the position route and wherein the user input comprises a user-defined route for a position. The user-defined route may be received as a touch input from the user. The method may further include enabling the user to selectively access portions of a video matching the search criteria.

In particular embodiments, the method may include enabling the user to create a playbook, including specifying a playbook identifier for the playbook, and enabling the user to access the playbook. Accessing the playbook may include at least one of accessing the playbook using the playbook identifier, adding a play to the playbook, deleting a play from the playbook, and modifying metadata associated with a play in the playbook.

In another aspect, a disclosed database system may be for retrieving plays. The database may include a processor configured to access memory media, and a database of plays, including formation data and position route data for each play stored in the database. The memory media may include instructions executable by the processor. The instructions, when executed by the processor, may cause the processor to perform operations including receiving a search criteria describing plays, issuing a query to the database for plays matching the search criteria, and outputting the plays resulting from the query. The search criteria may specify at least one of a formation and a position route.

In certain embodiments, the memory media may include instructions for receiving play data describing a new play, and adding the play data received to the database. The play data may include formation data and position route data for the new play. The database accommodates, for each play, metadata selected from a concept identifier describing a general football concept, a combination identifier describing position route data for at least two positions, a play identifier, a playbook identifier, a formation identifier, a plurality of player data identifiers, a video identifier, and position route identifiers for each of a plurality of positions. The search criteria include at least one of the concept identifier and the combination identifier.

In yet another aspect, transitory computer readable memory media may store executable instructions to receive user input indicating a search criteria, retrieve, from a database, plays matching the search criteria, and enable a user to select the plays matching the search criteria. The search criteria may specify at least one of a formation and a position route.

In the following description, details are set forth by way of example to facilitate discussion of the disclosed subject matter. It should be apparent to a person of ordinary skill in the field, however, that the disclosed embodiments are exemplary and not exhaustive of all possible embodiments.

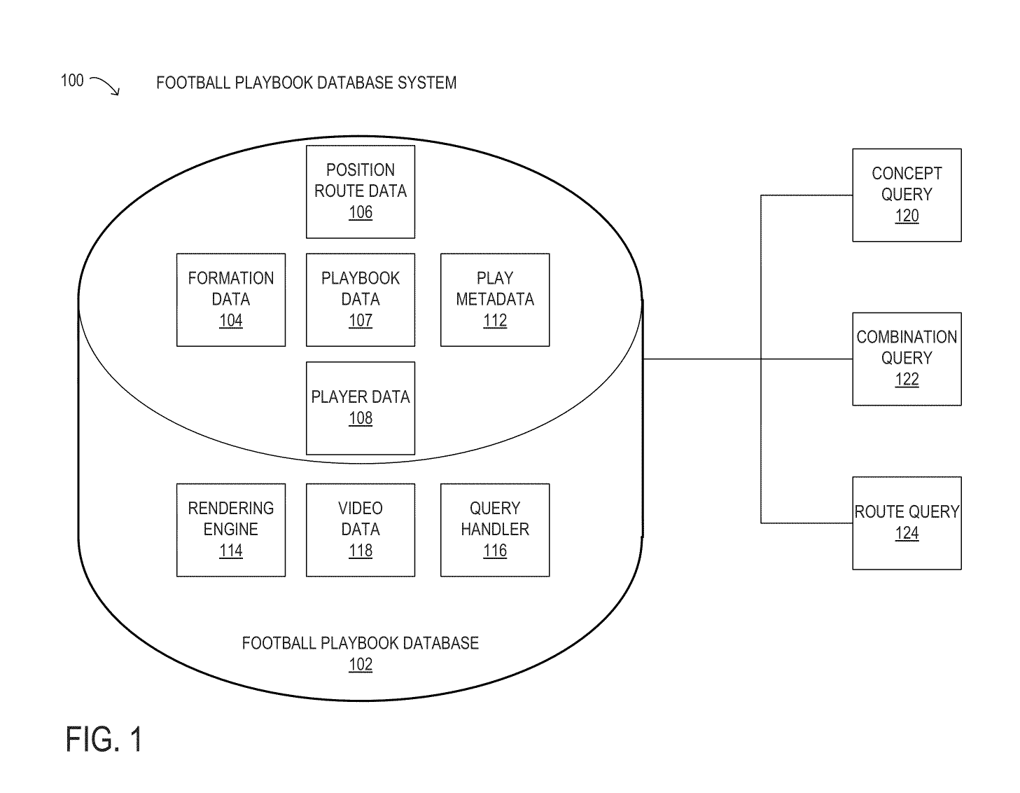

Turning now to the drawings, FIG. 1 is a block diagram of selected elements of play database system 100. As shown, football database system 100 includes play database 102, which may represent any of a variety of database types. In FIG. 1, various data elements and functionality are shown included with play database 102, which may be implemented by a computer system (not shown) integrated with play database 102. In various embodiments, play database system 100 may itself include a dedicated computer system (not shown), such as a database server, that enables access to play database 102 over a network. Accordingly, play database system 100 may include a processor, memory, and a network adapter (not shown in FIG. 1) in particular embodiments. Additionally, data described in association with play database 102 may be physically stored using a storage device (not shown).

As shown in FIG. 1, play database 102 includes formation data 104, which may specify a number of positions (not shown) and location data (not shown) for the positions. The positions may represent an offensive formation, a defensive formation, or another game formation. The positions are placed at start locations in the formation according to the location data and constitute the formation used at the beginning of a play. Accordingly, formation data 104 may include images or raw data or combinations thereof. The start locations in the location data may be specified for each position relative to an origin, such as, for example, a point of scrimmage representing a football on a line of scrimmage. Thus, the location data may include 2-dimensional coordinates to specify start locations. Other origins may be arbitrarily used in different embodiments, such as a corner of a play image space. In addition to location data, formation data 104 may include position data for each position in the formation. The position data may specify a position identifier for a given position. The position identifier may be a character that appears on the position in a play image and may be specified by a user or an entity using play database system 100 to implement a desired language or play environment. The location data and the position data may be used to generate and/or render the play image of a play for display to a user. It is noted that a number of positions (including location data for the positions, and position data for the positions) may vary in number and scope, as desired. In other words, formation data 104 may be usable to specify a full and/or a partial implementation of a formation. In various embodiments, formation data 104 may be used to specify a plurality of formations, which may be individually accessed using a formation identifier. For example, play metadata 112 may specify a list of plays stored in play database 102 and may include the formation identifier for each respective play, thereby specifying the formation used for that play.

Also in FIG. 1, play database 102 is shown including position route data 106, which may specify a designated route for a designated position. The designated route may originate at the start location for the designated position. Position route data 106 may include a number of designated routes that are specified for a given position. Position route data 106 may include designated routes for a plurality of positions. The designated route may be specified relative to the start location and may include 2-dimensional path data (not shown) at a desired level of granularity or precision. In certain embodiments, position route data 106 may include position route identifiers for each of a plurality of positions, whereby the position route identifiers are used to access path data for the route. In certain embodiments, position route data 106 may be maintained and/or rendered in image form by play database 102.

In FIG. 1, play database 102 is shown including play metadata 112, which may include information describing individual plays that are stored by play database 102. As noted above, play metadata 112 may include a formation identifier for each play, along with position route identifiers specifying position route data 106 for desired positions for the play. Thus, play metadata 112 may include additional identifiers for each individual play stored in play database 102, such as, but not limited to: a concept identifier describing a general football concept; a combination identifier describing position route data for at least two positions; a play identifier uniquely identifying a play; a playbook identifier uniquely identifying a playbook; a formation identifier uniquely identifying a formation; a plurality of player data identifiers describing attributes (or desired attributes) of individual athletes assigned to positions; a video identifier; and position route identifiers for each of a plurality of positions. In this manner, play metadata 112 may enable play database system 100 to provide users with the ability to search and/or browse plays stored in play database 102 according to various criteria and relevant attributes of individual plays, as will be described in further detail herein.

Also shown in FIG. 1, play database 102 includes playbook data 107. Playbook data 107 may be usable to generate playbooks, or collections of individual plays. Users may use playbook data 107 to create and store playbooks, but also to distribute playbooks to other users. For example, a football coach may prepare a playbook for an upcoming game and distribute the playbook electronically to players on the coach's team. Thus, playbook data 107 may include a playbook identifier, along with a plurality of play identifiers, to describe collections of plays in a playbook. In other embodiments, playbook data 107 may include rendered play images that are suitable for viewing and/or printing.

Still referring to FIG. 1, play database 102 is shown including player data 108, which may describe attributes of individual athletes who assume roles in positions. Player data 108 may be used to specify certain attributes of an athlete for a given play. For example, an age of an athlete may be used to discriminate certain plays (or entire playbooks) that are physically unsuitable for younger players. In certain embodiments, player data 108 may include attributes describing certain abilities of an individual athlete, such as a jump height, for example, which may be used to specify certain types of players in a play. Thus, certain plays stored in play database 102 may be linked, for example, using play metadata 112, to player data 108 to filter or specify attributes of players in positions.

As shown in FIG. 1, play database 102 also includes rendering engine 114, video data 118, and query handler 116. Rendering engine 114 may generate images, such as play images, from other data stored in play database 102, as described above. The rendered play images may be displayed to a user and/or included in a playbook. In play database 102, video data 118 may provide access to video that may be played to a user. Specifically, video data 118 may include actual video segments (or links to video segments stored externally to play database 102) that are indexed to individual plays stored in play database 102, for example, using play metadata 112. Query handler 116 may be a module within play database 102 that is capable of receiving queries and outputting results of the received queries. Examples of queries that may be received by play database 102 shown in FIG. 1 are concept query 120, combination query 122, and route query 124, as described previously.

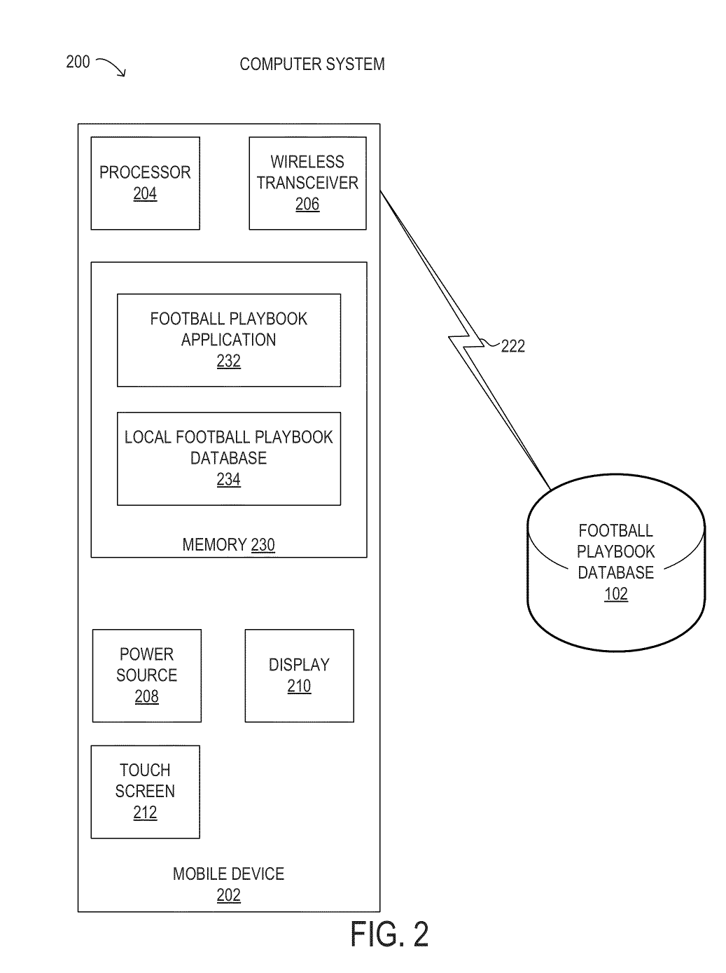

In operation, play database system 100 may enable play database 102 to be populated with data and/or images representing plays. A user and/or a provider of play database system 100 may populate play database 102 with plays. Once populated, a user may execute playbook application 232 (see FIG. 2) to access plays stored within play database 102. The access may include browsing or searching for individual plays using various criteria. For example, concept query 120 and combination query 122 may enable searching for plays based on high-level football concepts, while route query 124 may enable searching based on specific route paths for desired positions. The plays matching a received search criteria may be presented to the user as a collection of plays, which the user may view, browse, and/or select. Certain plays outputted to the user may be added to a playbook, which can be stored by the user and retrieved, for example, for distribution. Additionally, video segments of individual plays, when available, may be played back to a user of playbook application 232, and/or may be included with a playbook.

Referring now to FIG. 2, a block diagram of selected elements of an embodiment of computer system 200 is depicted. In computer system 200, mobile device 202 may represent a tablet, a smart phone, or another suitable mobile device and may communicate with play database 102 (see FIG. 1) via communication link 222, which may be a wireless link. In other embodiments (not shown) mobile device 202 may be replaced by a computer system, such as a personal computer, that is either mobile or stationary. As will be described below, certain contents of play database 102 may be located on a remote server or locally to mobile device 202 and may include various types of data related to plays, as mentioned previously.

In FIG. 2, processor 204 may represent at least one processing unit and may further include internal memory, such as a cache for storing processor executable instructions. In various embodiments, processor 204 is operable to perform operations associated with electronic playbooks, as described herein. Processor 204 may access memory 230 to receive executable instructions and/or to store data in memory 230.

In FIG. 2, wireless transceiver 206 may represent a communications transceiver providing an interface for any of a number of communication links. In certain embodiments, wireless transceiver 206 supports wireless communication links, such as infrared (IR), radio frequency (RF), and audio, among others. Examples of RF wireless links include the IEEE 802.xx family, such as WiFi® (IEEE 802.11) and Bluetooth® (IEEE 802.15.1). In addition to wireless transceiver 206, play database 102 may further support mechanically connected communication links, such as galvanically wired connections, sensor interface connections, connections to external antennas, network connections (i.e., Ethernet), etc. Wireless transceiver 206 may transform an instruction received from processor 204 into a signal sent via communication link 222. It is noted that wireless transceiver 206 may be a bidirectional interface, such that responses, such as commands, information, or acknowledgements, may be received via communication link 222.

In FIG. 2, mobile device 202 may represent a tablet, a smart phone, or another suitable mobile device with application processing capacity. Mobile device 202 may be in possession of a coach or other team official charged with planning and execution of plays in a football game. It is noted that an application executing on mobile device 202 may specifically be configured to operate with one or more instances of play database 102. Wireless transceiver 206 may further represent a client device in wireless network (not shown) that is accessible via communication link 222. The wireless network may be a wide-area wireless network, such as a cellular telephony network, for example, and may enable mobile device 202 to communicate with play database 102 to exchange application data, commands, and data, as desired.

In FIG. 2, memory 230 encompasses persistent and volatile media, fixed and removable media, magnetic and semiconductor media, or a combination thereof. Memory 230 is operable to store instructions, data, or both. Memory 230 as shown includes data, which may be in the form of sets or sequences of executable instructions, namely, playbook application 232 and local play database 234. Playbook application 232 may include processor executable instructions to enable access to electronic plays, as described herein. Local play database 234 may represent a local cache of at least a portion of play database 102 that may enable mobile device 202 to operate partially or completely independently. For example, local play database 234 may enable a user to continue using playbook application 232 even when communication link 222 (or another network link) is unavailable, and may automatically synchronize with play database 102 when communication link 222 becomes available.

Also shown included with mobile device 202 in FIG. 2 is power source 208, which may represent a local power source, such as a battery and/or an interface to an external power supply. Power source 208 may be configured for DC, AC or both, and may be configured to convert between various levels of AC and/or DC power. Power source 208 may be configured to regulate an output voltage or an output current, as desired. Mobile device 202 is shown in FIG. 2 including display 210, which may be implemented as a liquid crystal display screen, a light-emitting diode (LED) screen, a computer monitor, a television or the like. Display 210 may comply with a display standard for the corresponding type of display. Standards for computer monitors include analog standards such as video graphics array (VGA), extended graphics array (XGA), etc., or digital standards such as digital visual interface (DVI), and definition multimedia interface (HDMI), among others. A television display may comply with standards such as National Television System Committee (NTSC), Phase Alternating Line, (PAL), or another suitable standard. In conjunction with display 210, touch screen 212 may enable tactile input to content presented by display 210. In some embodiments, the user may choose a position that is an eligible receiver. The user may touch and drag their finger on touch screen 212 as if to draw an image of a desired route for that receiver. Mobile device 202 may capture the touch-generated image and search play database 102 for a route most similar to the image drawn by the user. The user could draw an image for one eligible receiver or for a plurality of eligible receivers. Mobile device 202 may display all plays from play database 102 that matched the criteria provided by the user.

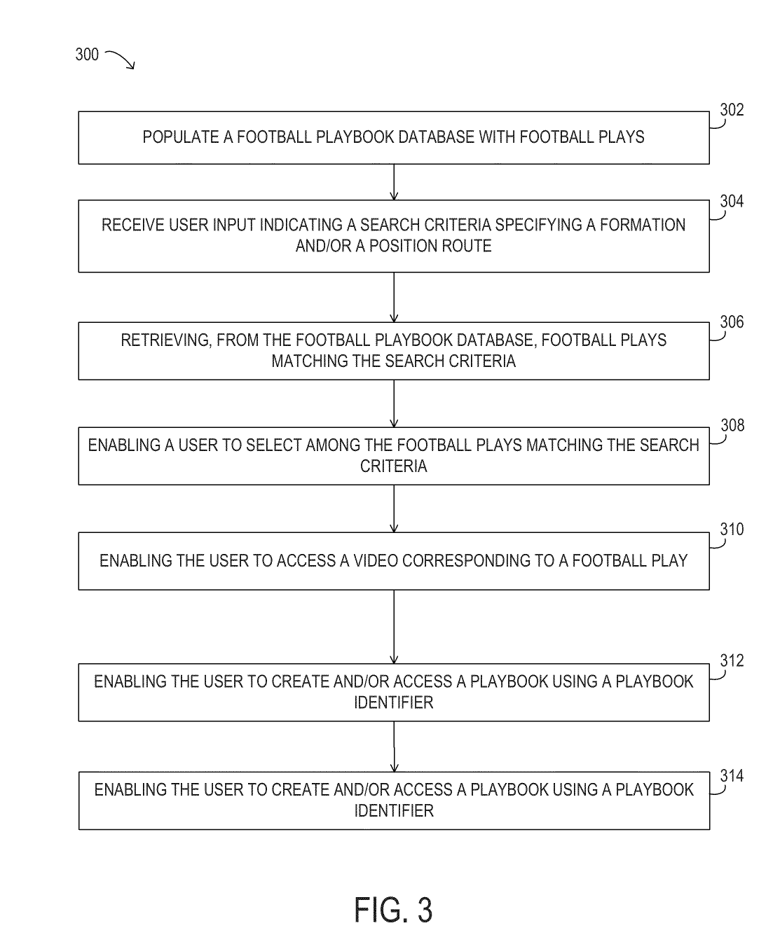

Turning now to FIG. 3, a block diagram of selected elements of an embodiment of method 300 for using an electronic playbook is depicted in flow-chart form. Method 300 may be performed using play database 102 and/or playbook application 232 (see FIGS. 1 and 2) in various embodiments. It is noted that certain operations described in method 300 may be optional or may be rearranged in different embodiments.

Method 300 may begin by populating (operation 302) a play database with plays. User input may be received (operation 304) indicating a search criteria specifying a formation and/or a position route. Plays matching the search criteria may be retrieved (operation 306) from the play database. A user may be enabled (operation 308) to select among the plays matching the search criteria. The user may be enabled to access (operation 310) a video corresponding to a play. The user may be enabled to create and/or access (operation 312) a playbook using a playbook identifier. In the embodiment depicted in FIG. 3, two or more users may be able to share access to a common set of plays, i.e., a common play database or a common playbook created by one of the users. For example, an offensive coordinator may access the active playbook for a team's upcoming game and add an offensive play to the playbook. The offensive coordinator might then save the revised playbook back to the play database and make it or keep it accessible to the all coaches and players, coaches and players with a need to know, and so forth.

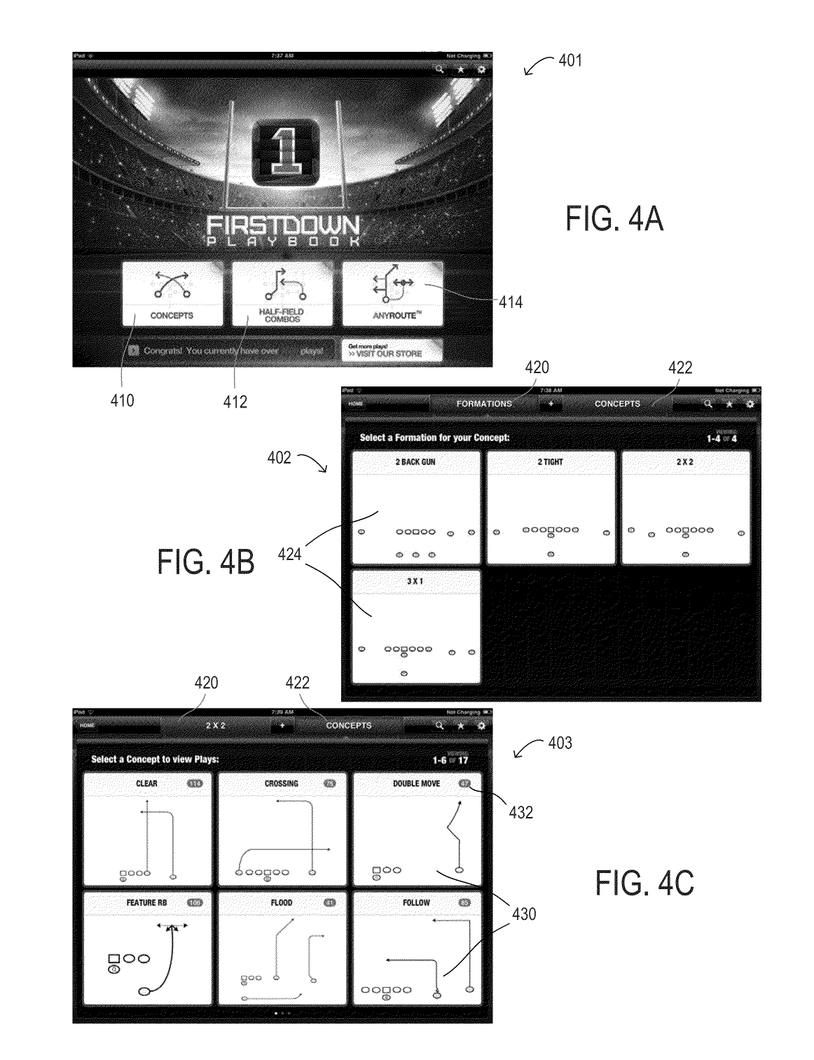

Turning now to FIGS. 4A, 4B, and 4C, display screens depicting selected elements of an embodiment of football playbook application 232 (see FIG. 2) are depicted. In FIGS. 4A-C, various user interfaces for performing a search query using football playbook application 232 are depicted. In FIG. 4A, screen 401 may be a launch screen for selecting “CONCEPTS”, “HALF-FIELD COMBOS”, and “ANYROUTE™”, which correspond respectively to concept query 120, combination query 122, and route query 124, as discussed above with respect to FIG. 1. Specifically, button 410 may select “CONCEPTS”, button 412 may select “HALF-FIELD COMBOS”, and button 414 may select “ANYROUTE™”. In FIG. 4B, after selecting button 410 for “CONCEPTS” in screen 401 (see FIG. 4A), screen 402 may appear showing formations 424 that are presented as various play images for selection. Also shown in screen 402 are formation display 420, which may show a current state of a formation selection, as well as detail display 422, which may show another current selection. In FIG. 4C, after selecting a formation called “2×2” in FIG. 4B, various concepts corresponding to the formation are presented as panels 430 showing play images for selection in screen 403. As shown, panels 430 each include play number indicator 432 showing a number of available plays (i.e., plays in the database matching the selected search criteria) for each respective instance of panels 430. In screen 403, formation display 420 shows “2×2” as the selected formation, while detail display 422 shows “CONCEPTS”.

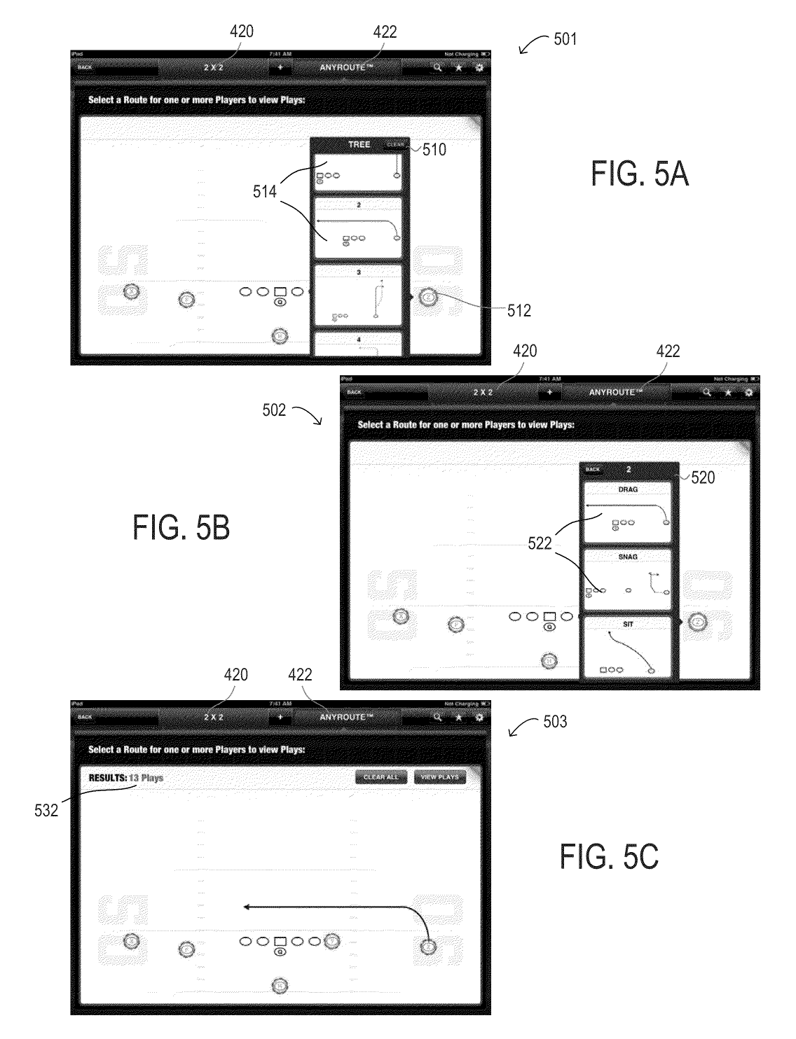

Turning now to FIGS. 5A, 5B, and 5C, display screens depicting selected elements of an embodiment of football playbook application 232 (see FIG. 2) are depicted. In FIGS. 5A-C, various user interfaces for selecting football plays retrieved using football playbook application 232 are depicted. The play images in FIG. 5A may represent a families of similar plays that may be presented after selection of button 414 “ANYROUTE™” in screen 402 (see FIG. 4A) and selection of a formation, which in screen 501 is a “2×2” formation. Accordingly, in screen 501 formation display 420 shows “2×2” while detail display 422 shows “ANYROUTE™”. In FIG. 5A, screen 501 may show tree 510 of plays that are presented as play images for selection. Specifically, tree 510 may include play images of route types 514 that may be selected. Additionally, a team position for restricting position routes may be selected, which in panel 501 is a “Z” receiver shown by indicator 512.

In FIG. 5B, after selecting route type 514 corresponding to “2” from tree 510 in screen 501 (see FIG. 5A), tree 520 in screen 502 may show routes 522 corresponding to route type 514 selected previously. For example, tree 520 may show a number of plays corresponding to a set of “2” routes that “Z” can run from a “2×2” formation for browsing and/or selection. In screen 502 formation display 420 shows “2×2” while detail display 422 shows “ANYROUTE™”. In FIG. 5C, screen 503 shows a selected play image representing the selected play from screen 502 (see FIG. 5B). In response to a user selecting “2 drag” from routes 522 (see FIG. 5B), a first of 13 plays satisfying the previously selected criteria for formation, position, and route is shown in screen 503, which includes indicator 532 showing the number of available plays. In screen 503 formation display 420 shows “2×2” while detail display 422 shows “ANYROUTE™”. While not depicted, the user can then browse through the set of 13 plays that satisfy the “ANYROUTE™” criteria, viewing each individual play as desired.

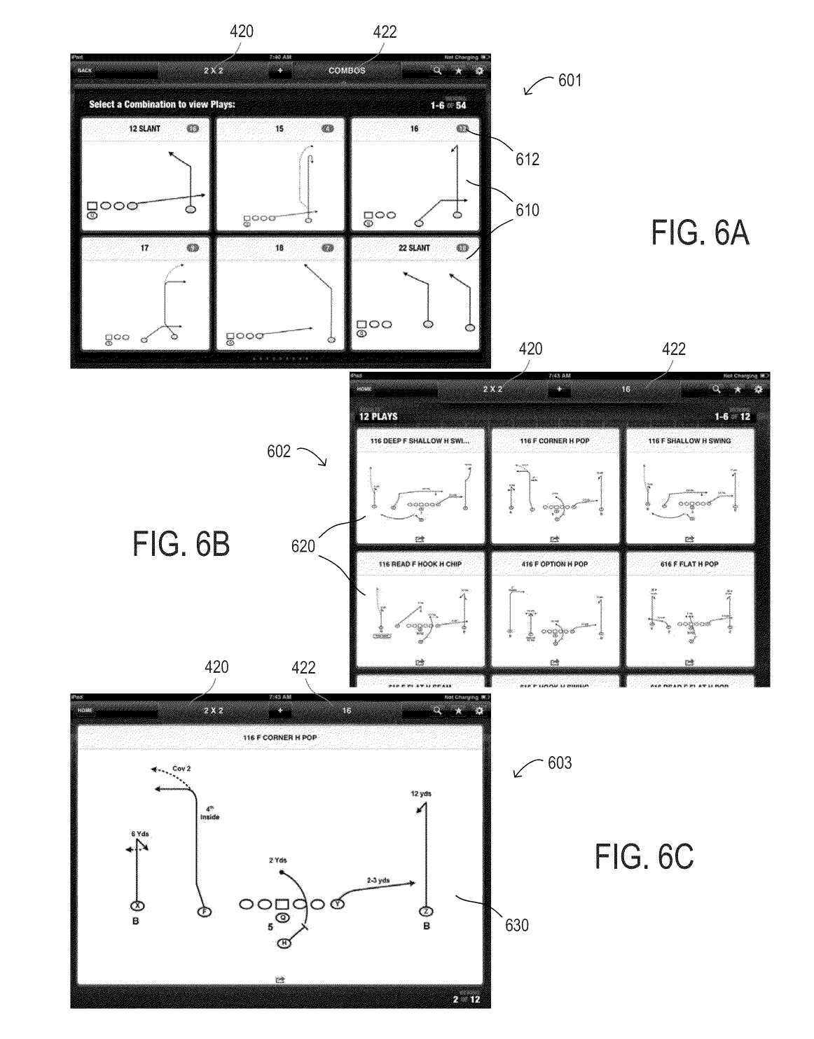

Turning now to FIGS. 6A, 6B, and 6C, display screens depicting selected elements of an embodiment of football playbook application 232 (see FIG. 2) are depicted. In FIGS. 6A-C, various user interfaces for selecting football plays retrieved using football playbook application 232 are depicted. In FIG. 6A, screen 601 shows play families corresponding to search criteria are presented as play images for selection. In FIG. 6A, screen 601 may show panels 610 representing combinations that are available for selection after choosing button 412 (“HALF-FIELD COMBOS”, see FIG. 4A) and selecting “2×2” from formations 424 in screen 402 (see FIG. 4B). Accordingly, in screen 601 formation display 420 shows “2×2” while detail display 422 shows “COMBOS”. In screen 601, each panel 610 may include indicator 612 shown a number of plays available for an individual combination. In screen 601 play images in panels 610 may represent families of similar plays that may be presented for selection.

In FIG. 6B, screen 602 shows panels 620 of individual plays presented after selection of a combination in screen 601 (see FIG. 6A). In screen 602, after selecting “16” from panels 610 (see FIG. 6A), panels 620 of play images of individual plays corresponding to a set of “16” combinations for a “2×2” formation are shown for browsing and/or selection. Accordingly, in screen 602 formation display 420 shows “2×2” while detail display 422 shows “16”. In FIG. 6C, screen 603 shows play image 630 representing a selected play from panel 603. In response to a user selecting “116 F CORNER H POP” from panel 602 (see FIG. 6B), play image 630 of the selected play is displayed in screen 603. In screen 603 formation display 420 shows “2×2” while detail display 422 shows “16”. It is noted that the user may rename (not shown) the play represented by the play image in FIG. 6C and may create (not shown) a playbook including the play, add (not shown) the play to an existing playbook, and rename (not shown) a playbook.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for accessing plays, the method comprising:
receiving user input indicating a search criteria, wherein the search criteria specifies at least one of: a formation and a position route;
identifying, from a database, plays matching the search criteria; and
enabling a user to select the plays matching the search criteria.

2. The method of claim 1, wherein the database stores formation data for the formation, the formation data including:
location data for each of a plurality of positions in the formation, wherein the location data specifies a start location, relative to a point of scrimmage, in the formation; and
position data for each of the plurality of positions, wherein the position data specifies a position identifier for a position in the formation.

3. The method of claim 2, wherein the database stores position route data for the position route, the position route data specifying:
a designated route for a designated position in the formation, the designated route originating from the start location for the designated position.

4. The method of claim 1, wherein enabling the user to select the plays comprises:
generating a play image for a first play matching the search criteria, wherein the play image represents formation data and position route data associated with the first play, wherein the generating the play image for the first play includes at least one of:
retrieving at least a portion of the play image from the database; and
rendering the play image using the formation data and the position route data.

5. The method of claim 1, wherein the search criteria specifies the position route, and wherein the user input comprises a user-defined route for a position.

6. The method of claim 5, wherein the user-defined route is received as a touch input from the user.

7. The method of claim 1, further comprising:
enabling the user to selectively access portions of a video matching the search criteria.

8. The method of claim 1, further comprising:
enabling the user to create a playbook, including specifying a playbook identifier for the playbook; and
enabling the user to access the playbook, including at least one of:
accessing the playbook using the playbook identifier;
adding a play to the playbook;
deleting a play from the playbook; and
modifying metadata associated with a play in the playbook.

9. A database system for retrieving plays, the database comprising:
a processor configured to access memory media;
a database of plays, including formation data and position route data for each play stored in the database; and
wherein the memory media include instructions executable by the processor, wherein the instructions, when executed by the processor, cause the processor to perform operations including:
receiving a search criteria describing plays, wherein the search criteria specifies at least one of: a formation and a position route;
issuing a query to the database for plays matching the search criteria; and
outputting the plays resulting from the query.

10. The database system of claim 9, wherein the formation data include:
location data for each of a plurality of positions in the formation, wherein the location data specifies a start location, relative to a point of scrimmage, in the formation; and
position data for each of the plurality of positions, wherein the position data specifies a position identifier for a position in the formation.

11. The database system of claim 10, wherein the position route data specifies:
a designated route for a designated position in the formation, the designated route originating from the start location for the designated position.

12. The database system of claim 9, wherein the memory media include instructions that, when executed by the processor, cause the processor to perform operations including:
receiving play data describing a new play, wherein the play data includes formation data and position route data for the new play; and
adding the play data received to the database.

13. The database system of claim 9, wherein the database accommodates, for each play, metadata selected from:
a concept identifier describing a general football concept;
a combination identifier describing position route data for at least two positions;
a play identifier;
a playbook identifier;
a formation identifier;
a plurality of player data identifiers;
a video identifier; and
position route identifiers for each of a plurality of positions.

14. The database system of claim 13, wherein the search criteria include at least one of: the concept identifier and the combination identifier.

15. Non-transitory computer readable memory media, the memory media storing executable instructions, the instructions including instructions to:
receive user input indicating a search criteria, wherein the search criteria specifies at least one of: a formation and a position route;
retrieve, from a database, plays matching the search criteria; and
enable a user to select the plays matching the search criteria.

16. The memory media of claim 15, wherein the database stores formation data for the formation, the formation data including:
location data for each of a plurality of positions in the formation, wherein the location data specifies a start location, relative to a point of scrimmage, in the formation; and
position data for each of the plurality of positions, wherein the position data specifies a position identifier for a position in the formation.

17. The memory media of claim 16, wherein the database stores position route data for the position route, the position route data specifying:
a designated route for a designated position in the formation, the designated route originating from the start location for the designated position.

18. The memory media of claim 15, wherein the database accommodates, for each play, metadata selected from:
a concept identifier describing a general football concept;
a combination identifier describing position route data for at least two positions;
a play identifier;
a playbook identifier;
a formation identifier;
a plurality of player data identifiers;
a video identifier; and
position route identifiers for each of a plurality of positions.

19. The memory media of claim 18, wherein the search criteria include at least one of: the concept identifier and the combination identifier.

20. The memory media of claim 15, further including instructions to:
enable the user to create a playbook, including specifying a playbook identifier for the playbook; and
enable the user to access the playbook, including at least one of:
accessing the playbook using the playbook identifier;
adding a play to the playbook;
deleting a play from the playbook; and
modifying metadata associated with a play in the playbook.
